(19) United States
(12) Patent Application Publication
(10) Pub. No.: US 2024/0363983 A1
(43) Pub. Date: Oct. 31, 2024

(54) CYLINDRICAL BATTERY CELL, BATTERY AND METHOD FOR FORMING CYLINDRICAL BATTERY CELL

(71) Applicant: HEFEI GOTION HIGH-TECH POWER ENERGY CO., LTD., Hefei, Anhui (CN)

(72) Inventors: Azad DARBANDI, Gottingen (DE); Tobias SCHMIEG, Gottingen (DE); Qian CHENG, Hefei, Anhui (CN); Chen LI, Hefei, Anhui (CN)

(21) Appl. No.: 18/287,871

(22) PCT Filed: Jul. 7, 2021
(86) PCT No.: PCT/CN2021/104895

§ 371 Date: Oct. 20, 2023

(51) Int. Cl. H01M 50/562; H01M 10/04; H01M 50/107; H01M 50/119; H01M 50/536; H01M 50/538; H01M 50/545; H01M 50/566

(52) U.S. Cl. CPC H01M 50/562; H01M 10/0422; H01M 10/0431; H01M 50/107; H01M 50/119; H01M 50/536; H01M 50/538; H01M 50/545; H01M 50/566

(57) ABSTRACT

A cylindrical battery cell, a battery and a method for forming cylindrical battery cell are provided. In the cylindrical battery cell, a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### CROSS REFERENCE TO RELATED APPLICATION(S)

The present disclosure is a national stage application of International Patent Application No. PCT/CN2021/104895, which is filed on Jul. 7, 2021 and entitled “Cylindrical battery cell, Battery and Method for forming cylindrical battery cell”, the disclosure of which is hereby incorporated by reference in its entirety.

### TECHNICAL FIELD

Embodiments of the present disclosure generally relate to the field of battery, and more particularly, to a cylindrical battery cell, a battery and a method for forming cylindrical battery cell.

### BACKGROUND

A battery (such as an automotive battery) in general includes a plurality of battery cell. As a kind of battery cell, a cylindrical battery cell is used recently. For example, formfactors of the cylindrical battery cell may be from 2170 (diameter is 21 mm and height is 70 mm) to 50120 (diameter is 50 mm and height is 120 mm), and the cylindrical battery cell may at least include a cell housing and a jellyroll structure.

In general, the cylindrical battery cell needs to have a special current path within a cell design in order to ensure enough ampacity. Hence a resistive spot welding of an anode current collector to a steel cell housing is not applicable for larger cell sizes (e.g. 4680 or larger). In some schemes, it is suggested to join a copper current collector and a steel cell housing by long welding seam created by a laser beam or an ultrasonic.

This section introduces aspects that may facilitate a better understanding of the disclosure. Accordingly, the statements of this section are to be read in this light and are not to be understood as admissions about what is in the prior art or what is not in the prior art.

### SUMMARY

However, the inventors found that in some existing schemes, there are several difficulties, challenges and risks in welding copper to steel. For example, copper and steel have quite different melting points (1085° C. vs. 1450° C.). Almost 400° C. difference in melting point makes a proper adjustment of laser beam intensity rather challenging. Furthermore, joining/welding can be only achieved, in case a laser beam hits a copper surface. This means, the joining of a cell housing and a copper current collector cannot be performed from outside of the cell housing. Furthermore, welding of Cu and Nickel-Plated Steel can affect Nickel coating, which potentially introduce risk of corrosion of cell housing, which in terms may potentially lead to cell internal short circuit by transportation of corrosion products.

In order to solve at least part of the above problems, methods and devices are provided in the present disclosure Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a cylindrical battery cell, a battery and a method for forming cylindrical battery cell. It is expected to join/weld the cell housing with the jellyroll structure by using a laser from outside of the cell housing, while risk of corrosion of cell housing is not introduced.

In a first aspect, a cylindrical battery cell is provided. The cylindrical battery cell at least includes: a cell housing having a cylindrical lateral portion and a bottom portion, and a jellyroll structure which is arranged inside the cell housing;

wherein a copper plate is forged with the bottom portion inside of the cell housing to form a bi-metal plate on a bottom side of the cell housing, and the copper plate is welded with the jellyroll structure.

In some embodiments, the copper plate is welded with the jellyroll structure by using a laser from outside of the cell housing.

In some embodiments, a thickness of the copper plate is determined according to a thickness of a flattened tab of the jellyroll structure on a bottom side of the jellyroll structure.

In some embodiments, one or more flattened tabs of the jellyroll structure are welded with the copper plate by using a laser after the jellyroll structure is inserted into the cell housing.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

In some embodiments, the cell housing is made up of steel, and the bi-metal plate is formed by using a forging process on the bottom side of the cell housing.

In a second aspect, a method for forming cylindrical battery cell is provided. The method includes: forming a cell housing having a cylindrical lateral portion and a bottom portion; inserting a copper plate into the cell housing: forging the copper plate with the bottom portion inside of the cell housing to form a bi-metal plate on a bottom side of the cell housing; inserting a jellyroll structure into the cell housing; and welding the copper plate and the jellyroll structure on the bottom side of the cell housing.

In a third aspect, a battery is provided, the battery includes a plurality of the cylindrical battery cells according to the first aspect of the embodiments.

According to various embodiments of the present disclosure, a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a cylindrical battery cell in accordance with an embodiment of the present disclosure;

FIG. 2 is a diagram which shows a section view of the cylindrical battery cell in accordance with an embodiment of the present disclosure;

FIG. 3 is a diagram which shows a method for forming cylindrical battery cell in accordance with an embodiment of the present disclosure;

FIG. 4 is a diagram which shows a cell housing with a copper plate in accordance with an embodiment of the present disclosure;

FIG. 5 is a diagram which shows a cell housing forging a copper plate in accordance with an embodiment of the present disclosure;

FIG. 6 is another diagram which shows a cell housing forging a copper plate in accordance with an embodiment of the present disclosure;

FIG. 7 is a diagram which shows a cell housing and a jellyroll structure in accordance with an embodiment of the present disclosure;

FIG. 8 is another diagram which shows a cell housing and a jellyroll structure in accordance with an embodiment of the present disclosure;

FIG. 9 is a diagram which shows a battery in accordance with an embodiment of the present disclosure.

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” has, “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein

### A First Aspect of Embodiments

A cylindrical battery cell is provided in the embodiments.

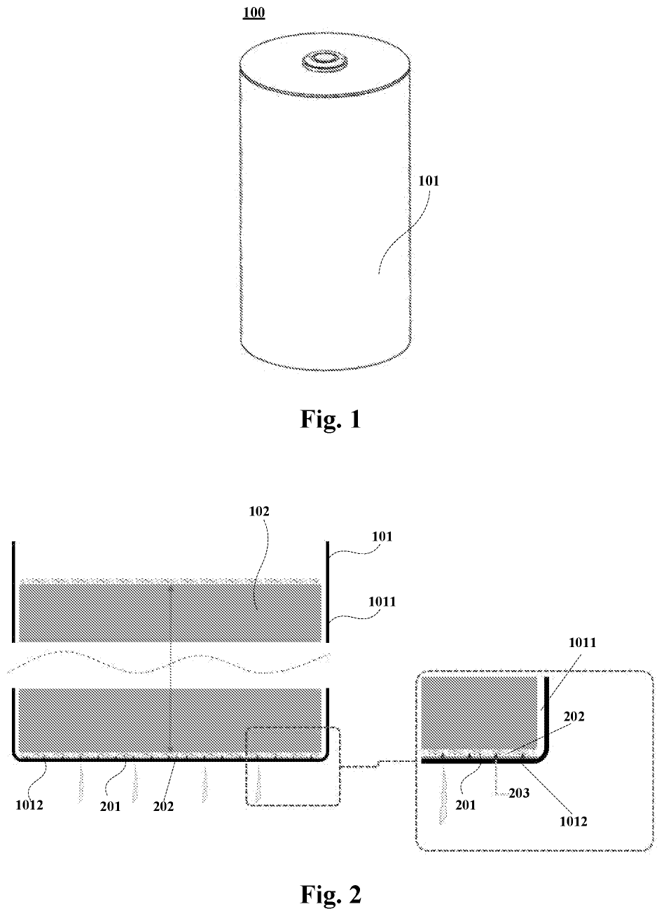

FIG. 1 is a diagram which shows a cylindrical battery cell 100 in accordance with an embodiment of the present disclosure. FIG. 2 is a diagram which shows a section view of the cylindrical battery cell 100 in accordance with an embodiment of the present disclosure.

As shown in FIG. 1 and FIG. 2, a cylindrical battery cell 100 at least includes: a cell housing 101 and a jellyroll structure 102. The cell housing 101 have a cylindrical lateral portion 1011 and a bottom portion 1012.

The jellyroll structure 102 is arranged inside the cell housing 101. For example, the jellyroll structure 102 includes a rolled anode foil, a rolled cathode foil and a rolled separator between the rolled anode foil and the rolled cathode foil. As for the detail of the jellyroll structure 102, please refer to relevant art.

As shown in FIG. 2, a copper plate 201 is forged with the bottom portion 1012 inside of the cell housing 101 to form a bi-metal plate on a bottom side of the cell housing 101, and the copper plate 201 is welded with the jellyroll structure 102.

For example, the bi-metal plate is formed by the copper plate 201 and the bottom portion 1012 of the cell housing 101. The bi-metal plate is a cu-steel plate while the copper plate 201 is arranged inside of the cell housing 101.

It should be appreciated that some components or elements are illustrated only as examples in FIG. 1 and FIG. 2. However, it is not limited thereto, for example, connections or positions of the components of elements may be adjusted, and/or, some components or elements may be omitted. For example, the cylindrical battery cell 100 may include a cap component, and it is not limited thereto.

In this disclosure, the bi-metal plate is formed at the bottom side of the cell housing 101, and the copper plate 201 is welded with the jellyroll structure 102 by using a laser from outside of the cell housing 101. Therefore, joining/welding the cell housing with the jellyroll structure is achieved by using a laser from outside of the cell housing, while risk of corrosion of cell housing is not introduced.

In this disclosure, a laser is used to weld the copper plate 201 inside of the cell housing 101 with the jellyroll structure 102, but it is not limited thereto For example, other ways such as an ultrasonic may be used in the welding process.

In some embodiments, the copper plate 201 is welded with the jellyroll structure 101 by using a laser from outside of the cell housing 101. For example, as shown in FIG. 2, some dots 203 are used to demonstrate laser welding footprints.

In some embodiments, a thickness of the copper plate is determined according to a thickness of a flattened tab of the jellyroll structure on a bottom side of the jellyroll structure. For example, the shape/thickness of copper plate 201 can be adjusted by tooling on demand according to requirement.

In some embodiments, one or more flattened tabs of the jellyroll structure are welded with the copper plate by using a laser after the jellyroll structure is inserted into the cell housing. For example, there is not a pre-welded copper current collector.

As shown in FIG. 2, there are one or more flattened tabs 202 in the jellyroll structure 102 one the bottom side of the jellyroll structure 102. The flattened tabs 202 of the jellyroll structure 102 are welded with the copper plate 201 by using a laser after the jellyroll structure 102 is inserted into the cell housing 101.

Therefore, the copper plate (Cu) inside of the cell housing will be laser welded to the tabs (Cu) afterwards, such that there is not difference in melting point when welding. Furthermore, a copper current collector is intendedly not considered in this example. The copper plate inside of the cell housing will be directly laser welded to the flattened copper tabs of the jellyroll structure. Consequently, a manufacturing process, welding a current collector (Cu) to tabs is skipped, which reduces manufacturing costs.

In some embodiments, a thickness (D1) of the copper plate 201 is equal to a thickness (D2) of the cell housing 101, or is smaller than a predetermined threshold (T1). For example, D1=D2, or D1<T1, and it is not limited thereto.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

For example, the flattened tabs 202 of the jellyroll structure 102 are pre-welded with a copper current collector on the bottom side of the jellyroll structure 102, and the copper plate 201 is welded with the copper current collector by using a laser after the jellyroll structure 102 is inserted into the cell housing 101.

Therefore, the copper current collector is pre-welded to the flattened copper tabs. The copper plate (Cu) inside of the cell housing will be laser welded to the copper current collector (Cu) afterwards, such that there is not difference in melting point when welding.

In some embodiments, the cell housing is made up of steel, and the bi-metal plate is formed by a forging process on the bottom side of the cell housing However, it is not limited thereto.

In this disclosure, copper is configured inside of a cell housing by a bi-metal forging process. For example, a copper plate is forged on the bottom side of the cell housing. The shape and thickness of the copper plate can be adjusted by tooling. Different shape and thickness of the copper plate may provide and enhance variety of cell properties, regarding thermal management and cooling system.

After inserting of the jellyroll structure into the cell housing, cell bottom (copper plate) can be penetration laser welded directly to the jellyroll structure, from outside of the cell housing. For example, the jellyroll structure can be pre-welded its own current collector (copper disk). For another example, it is possible to laser weld the copper plate directly to flattered tabs.

In this disclosure, joining of a copper plate to a steel cell housing by enabling laser welding from outside of the cell housing can be achieved, and the risk of corrosion within cell can be eliminated. Furthermore, the technique solution of this disclosure can maximize a space usage at the bottom side of the cell housing (higher volumetric filling ratio, higher energy content per cell, lower cost per cell mechanic).

In addition, the technical solution enhances substantially a thermal conduction path at the cell bottom. Concurrently, a high in-plane thermal conduction of jellyroll structure (in vertical axis) is achieved, this enables implementation of bottom cooling at module/pack level.

For example, implementation of bottom cooling increases volumetric filling ratio at module/pack level by minimize 5%. Implementation of bottom cooling resolves many technical challenges in integration and reduces manufacturing costs.

It is to be understood that, the above examples or embodiments are discussed for illustration, rather than limitation. Those skilled in the art would appreciate that there may be many other embodiments or examples within the scope of the present disclosure.

It can be seen from the above embodiments, a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### A Second Aspect of Embodiments

A method for forming cylindrical battery cell is provided in the embodiments. The corresponding devices are illustrated in the first aspect of embodiments, and the same contents as those in the first aspect of embodiments are omitted

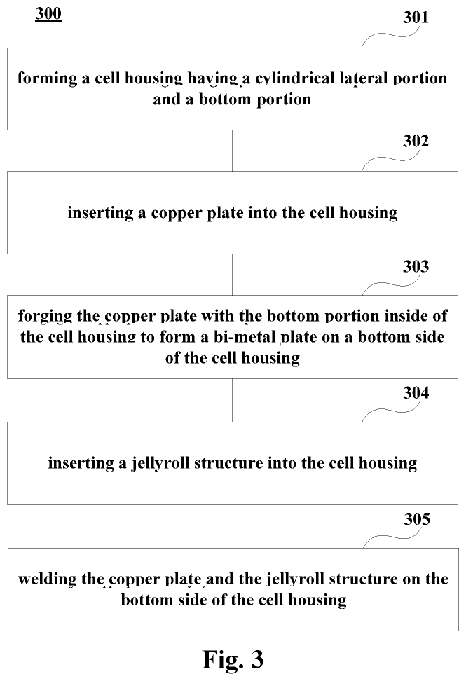

FIG. 3 is a diagram which shows a method for forming cylindrical battery cell in accordance with an embodiment of the present disclosure. As shown in FIG. 3, a method 300 for forming cylindrical battery cell includes:

301, forming a cell housing having a cylindrical lateral portion and a bottom portion;

302, inserting a copper plate into the cell housing;

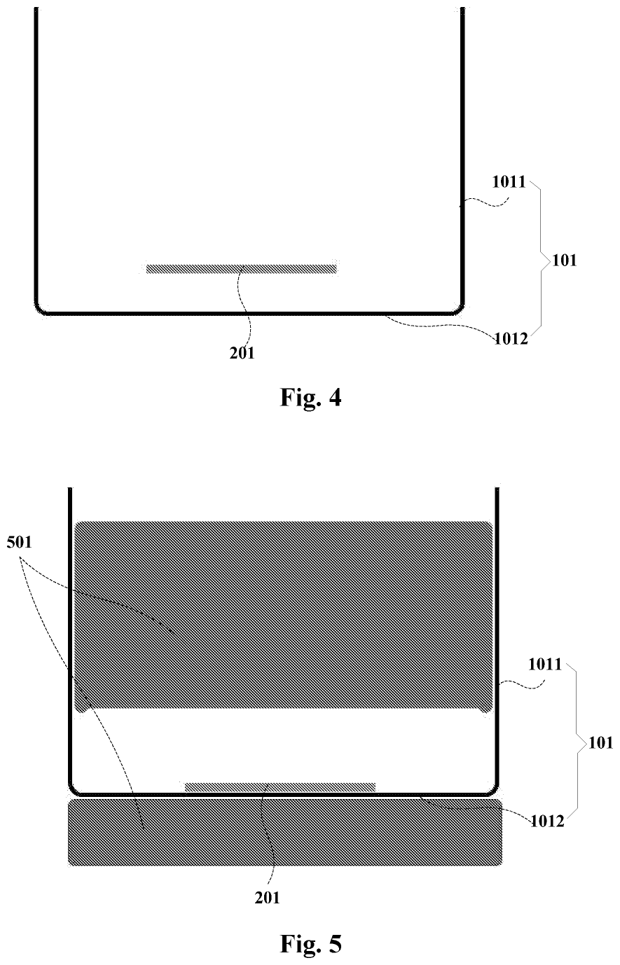

FIG. 4 is a diagram which shows a cell housing with a copper plate in accordance with an embodiment of the present disclosure. As shown in FIG. 4, a copper plate 201 is inserted into the cell housing 101

As shown in FIG. 3, a method 300 for forming cylindrical battery cell includes:

303, forging the copper plate with the bottom portion inside of the cell housing to form a bi-metal plate on a bottom side of the cell housing;

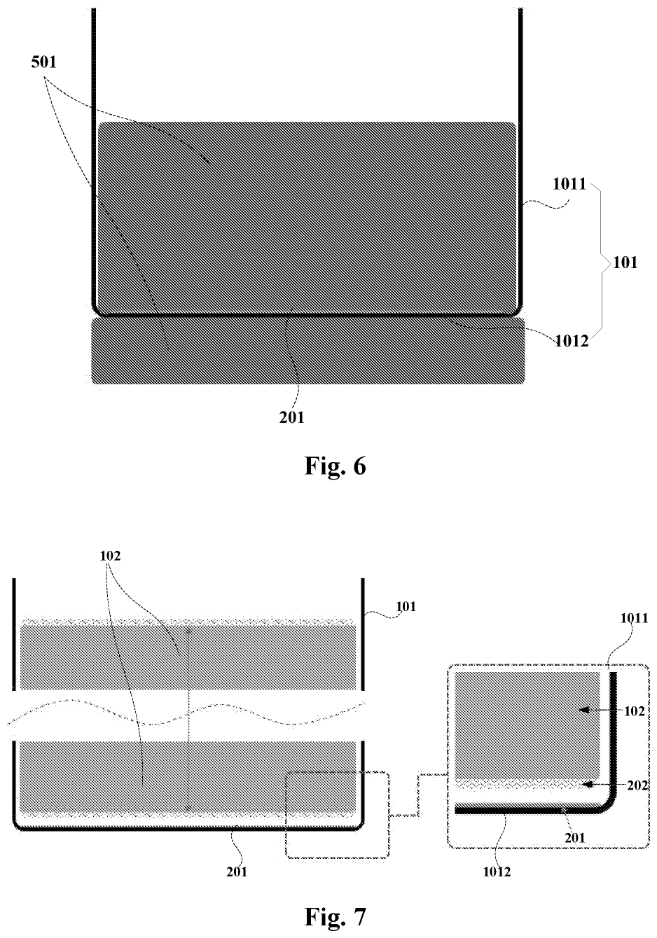

FIG. 5 is a diagram which shows a cell housing forging a copper plate in accordance with an embodiment of the present disclosure; FIG. 6 is another diagram which shows a cell housing forging a copper plate in accordance with an embodiment of the present disclosure.

As shown in FIG. 3, a forging machine 501 is introduced. As shown in FIG. 6, a forging process is executed and a bi-metal plate is formed.

As shown in FIG. 3, a method 300 for forming cylindrical battery cell includes:

304, inserting a jellyroll structure into the cell housing.

FIG. 7 is a diagram which shows a cell housing and a jellyroll structure in accordance with an embodiment of the present disclosure. As shown in FIG. 7. the jellyroll structure 102 is inserted into the cell housing 101.

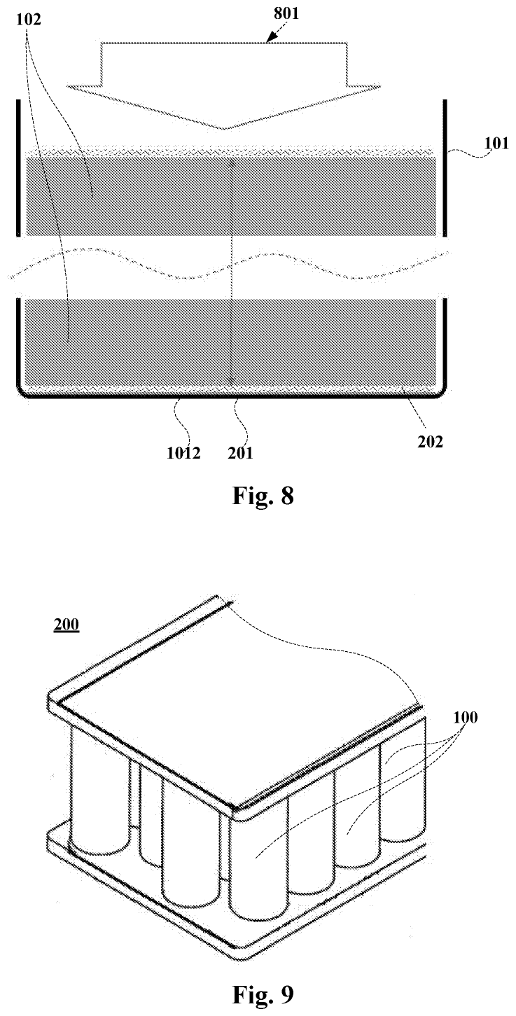

FIG. 8 is another diagram which shows a cell housing and a jellyroll structure in accordance with an embodiment of the present disclosure. As shown in FIG. 8, after the jellyroll structure 102 is inserted into the cell housing 101, a force 801 is applied to insure a gap-free interface between the bi-metal plate (the bottom portion 1012 and the copper plate 201) of the cell housing 101 and the tabs 202 of the jellyroll structure 102.

As shown in FIG. 3, a method 300 for forming cylindrical battery cell includes.

305, welding the copper plate and the jellyroll structure on the bottom side of the cell housing.

As shown in FIG. 2, the copper plate 201 inside of the cell housing 101 is weld (some dots in FIG. 2 are used to demonstrate laser welding footprints) with the jellyroll structure 102 by using a laser from outside of the cell housing.

It should be appreciated that FIG. 3 is only an example of the disclosure, but it is not limited thereto. For example, the order of operations at blocks or steps may be adjusted, and/or, some blocks or steps may be omitted. Moreover, some blocks or steps not shown in FIG. 3 may be added.

Furthermore, some components or elements are illustrated only as examples in FIG. 4 to FIG. 8. However, it is not limited thereto, for example, connections or positions of the components or elements may be adjusted, and/or, some components or elements may be omitted.

In some embodiments, the copper plate is welded with the jellyroll structure by using a laser from outside of the cell housing.

In some embodiments, a thickness of the copper plate is determined according to a thickness of a flattened tab of the jellyroll structure on a bottom side of the jellyroll structure.

In some embodiments, one or more flattened tabs of the jellyroll structure are welded with the copper plate by using a laser after the jellyroll structure is inserted into the cell housing.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

In some embodiments, the cell housing is made up of steel, and the bi-metal plate is formed by using a forging process on the bottom side of the cell housing.

It can be seen from the above embodiments, a copper plate is forged with the cell housing to form a bi-metal plate on the bottom side of the cell housing, and the copper plate is welded with the jellyroll structure. Therefore, joining/welding the cell housing with the jellyroll structure is achieved by using a laser from outside of the cell housing, while risk of corrosion of cell housing is not introduced.

### A Third Aspect of Embodiments

A battery is provided in the embodiments. The corresponding devices and the method are illustrated in the first and second aspects of embodiments, and the same contents as those in the first and second aspects of embodiments are omitted.

In some embodiments, the battery includes a plurality of the cylindrical battery cell. The cylindrical battery cell is illustrated according to the first aspects of embodiments.

FIG. 9 is a diagram which shows a battery 200 in accordance with an embodiment of the present disclosure. As shown in FIG. 9, the battery 200 may include a plurality of the cylindrical battery cell 100.

It should be appreciated that FIG. 9 is only an example of the disclosure, but it is not limited thereto. For example, some components or elements are illustrated only as examples in FIG. 9. However, it is not limited thereto, for example, connections or positions of the components or elements may be adjusted, and/or, some components or elements may be omitted.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A cylindrical battery cell, at least comprising:
a cell housing having a cylindrical lateral portion and a bottom portion; and
a jellyroll structure which is arranged inside the cell housing;
wherein a copper plate is forged with the bottom portion inside of the cell housing to form a bi-metal plate on a bottom side of the cell housing, and the copper plate is welded with the jellyroll structure.

2. The cylindrical battery cell according to claim 1, wherein the copper plate is welded with the jellyroll structure by using a laser from outside of the cell housing.

3. The cylindrical battery cell according to claim 1, wherein a thickness of the copper plate is determined according to a thickness of a flattened tab of the jellyroll structure on a bottom side of the jellyroll structure.

4. The cylindrical battery cell according to claim 1, wherein one or more flattened tabs of the jellyroll structure are welded with the copper plate by using a laser after the jellyroll structure is inserted into the cell housing.

5. The cylindrical battery cell according to claim 1, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

6. The cylindrical battery cell according to claim 1, wherein the cell housing is made up of steel, and the bi-metal plate is formed by using a forging process on the bottom side of the cell housing.

7. A method for forming cylindrical battery cell, comprising:
forming a cell housing having a cylindrical lateral portion and a bottom portion;
inserting a copper plate into the cell housing;
forging the copper plate with the bottom portion inside of the cell housing to form a bi-metal plate on a bottom side of the cell housing,
inserting a jellyroll structure into the cell housing; and
welding the copper plate and the jellyroll structure on the bottom side of the cell housing.

8. The method according to claim 7, wherein the copper plate is welded with the jellyroll structure by using a laser from outside of the cell housing.

9. The method according to claim 7, wherein a thickness of the copper plate is determined according to a thickness of a flattened tab of the jellyroll structure on a bottom side of the jellyroll structure.

10. The method according to claim 7, wherein one or more flattened tabs of the jellyroll structure are welded with the copper plate by using a laser after the jellyroll structure is inserted into the cell housing.

11. The method according to claim 7, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

12. The method according to claim 7, wherein the cell housing is made up of steel, and the bi-metal plate is formed by using a forging process on the bottom side of the cell housing.

13. A battery, comprising a plurality of cylindrical battery cells according to claim 1.

14. The battery according to claim 13, wherein the copper plate is welded with the jellyroll structure by using a laser from outside of the cell housing.

15. The battery according to claim 13, wherein a thickness of the copper plate is determined according to a thickness of a flattened tab of the jellyroll structure on a bottom side of the jellyroll structure.

16. The battery according to claim 13, wherein one or more flattened tabs of the jellyroll structure are welded with the copper plate by using a laser after the jellyroll structure is inserted into the cell housing.

17. The battery according to claim 13, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

18. The battery according to claim 13, wherein the cell housing is made up of steel, and the bi-metal plate is formed by using a forging process on the bottom side of the cell housing.
